(19) United States
(12) Patent Application Publication
(10) Pub. No.: US 2013/0089138 A1
(43) Pub. Date: Apr. 11, 2013

(54) CODING SYNTAX ELEMENTS USING VLC CODEWORDS

(71) Applicants: Liwei Guo, San Diego, CA (US); Joel Sole Rojals, La Jolla, CA (US); Marta Karczewicz, San Diego, CA (US); Xianglin Wang, San Diego, CA (US)

(72) Inventors: Liwei Guo, San Diego, CA (US); Joel Sole Rojals, La Jolla, CA (US); Marta Karczewicz, San Diego, CA (US); Xianglin Wang, San Diego, CA (US)

(73) Assignee: QUALCOMM INCORPORATED, San Diego, CA (US)

(21) Appl. No.: 13/533,849

(22) Filed: Jun. 26, 2012

Related U.S. Application Data
(60) Provisional application No. 61/501,568, filed on Jun. 27, 2011.
(60) Provisional application No. 61/501,575, filed on Jun. 27, 2011.
(60) Provisional application No. 61/505,509, filed on Jul. 7, 2011.
(60) Provisional application No. 61/538,673, filed on Sep. 23, 2011.
(60) Provisional application No. 61/552,366, filed on Oct. 27, 2011.

(51) Int. Cl. H04N 7/26

(52) U.S. Cl. CPC H04N 19/00121
USPC 375/240.03; 375/240.18

(57) ABSTRACT

This disclosure describes techniques for coding transform coefficients for a block of video data. For example, according to one embodiment, a video encoder determines an lrg1Pos value associated with the transform coefficient based on the noTr1 value and a position k of the transform in the scan order of the block of video data based on using at least one table that defines an lrg1Pos value for more than one potential noTr1 value for the scan order of the block of video data. In one embodiment, the video decoder uses the determined lrg1Pos value associated with the transform coefficient to perform a structured mapping to determine a code number cn based on a determined value for the level_ID syntax element and a determined value for the run syntax element.

This application claims priority to the following U.S. Provisional Applications, the entire contents each of which is incorporated herein by reference:
U.S. Provisional Application 61/501,568, filed Jun. 27, 2011;
U.S. Provisional Application 61/501,575, filed Jun. 27, 2011;
U.S. Provisional Application 61/505,509, filed Jul. 7, 2011;
U.S. Provisional Application 61/538,673, filed Sep. 23, 2011; and
U.S. Provisional Application 61/552,366, filed Oct. 27, 2011.

### TECHNICAL FIELD

This disclosure relates to video coding and compression. More specifically, this disclosure is directed to techniques using variable length coding (VLC) to encode transform coefficients for one or more blocks of video data.

### BACKGROUND

Entropy encoding is a method widely employed in video coding to compress video data. According to some aspects of entropy encoding, the video encoder scans a two-dimensional matrix of transform coefficients that represent pixels of an image, to generate a one-dimensional vector of the transform coefficients. In many applications, the video encoder advantageously employs the method of quantizing the transform coefficients to further compress the video data. A video decoder decodes the video data. As part of the decoding process, the video decoder scans the one-dimensional vector of transform coefficients, to reconstruct the two-dimensional matrix of transform coefficients.

### SUMMARY

In general, this disclosure describes techniques for coding video data, specifically techniques relating to scanning transform coefficients during a video coding process. In some examples, the video encoder is configured to use variable length codes (VLCs) to represent the various possible values associated with the quantized transform coefficient array generated during entropy encoding. In such instances, intermediate steps of the encoding process rely on using at least one value stored in memory. This disclosure describes methods to minimize or reduce the memory resources required in order to implement VLC coding of video data.

The details of one or more examples are set forth in the accompanying drawings and the description below. Other features, objects, and advantages of the invention will be apparent from the description and drawings, and from the claims.

One embodiment includes a method of encoding a block of video data. The method includes determining value of a level_ID syntax element indicating whether the transform coefficient has a magnitude of one or greater than one, a run value indicating a number of zero-value coefficients between the current coefficient and a next non-zero coefficient in a scan order of the block of video data, a noTr1 value indicating a number of previously coded transform coefficients of the block with an amplitude equal to one. At least one parameter is determined and stored in memory, for instance lrg1Pos, associated with the transform coefficient based on the noTr1 value and a position k of the transform in the scan order of the block of video data based on using at least one table that defines one value of the at least one parameter for more than one potential noTr1 value for the scan order of the block of video data. The determined value of the at least one parameter associated with the transform coefficient is used to perform a structured mapping to determine a code number cn based on the determined value for the level_ID syntax element and the determined value for the run syntax element. The code number cn is in turn used to determine a VLC code word comprising the output of the encoder.

Another embodiment includes a processor is configured to encode a block of video data by determining: a value of a level_ID syntax element indicating whether the transform coefficient has a magnitude of one or greater than one, a run value indicating a number of zero-value coefficients between the current coefficient and a next non-zero coefficient in a scan order of the block of video data, and a noTr1 value indicating a number of previously coded transform coefficients of the block with an amplitude equal to one. The processor of this example is also configured to determine a value of at least one parameter, for instance lrg1Pos, associated with the transform coefficient based on the noTr1 value and a position k of the transform coefficient in the scan order of the block of video data based on using at least one table that defines a value of the at least one parameter for more than one potential noTr1 value for the scan order of the block of video data, and use the determined value of the at least one parameter associated with the transform coefficient to perform a structured mapping to determine a code number cn based on the determined value for the level_ID syntax element and the determined value for the run syntax element. The exemplary processor further configured to use the determined code number cn to determine a VLC code word and output the determined VLC code word.

One embodiment includes a method of decoding a block of video data. The method includes determining: a code number cn based on a VLC code word associated with a transform coefficient of a block of video data, a noTr1 value associated with the transform coefficient, wherein the noTr1 value indicates a number of previously coded transform coefficients of the block with an amplitude equal to one, and a value of at least one parameter, for instance lrg1Pos, associated with the transform coefficient based on the noTr1 value and a position k of the transform in the scan order of the block of video data based on using at least one table that defines a value of the at least one parameter for more than one potential noTr1 value for the scan order of the block of video data. Further according to this embodiment, the determined value of the at least one parameter associated with the transform coefficient is used to perform a structured mapping to determine a value for a level_ID syntax element and a value for a run syntax element based on the determined code number cn, and the determined value for the level_ID syntax element and the determined value for the run syntax element are used to decode the block of video data.

Another embodiment includes a processor is configured to decode a block of video data by determining: a code number cn based on a VLC code word associated with a transform coefficient of a block of video data, a noTr1 value associated with the transform coefficient, wherein the noTr1 value indicates a number of previously coded transform coefficients of the block with an amplitude equal to one, and a value of at least one parameter, for instance lrg1Pos, associated with the transform coefficient based on the noTr1 value and a position k of the transform in the scan order of the block of video data based on using at least one table that defines a value of the at least one parameter for more than one potential noTr1 value for the scan order of the block of video data. The processor of this example is also configured to use the determined value of the at least one parameter associated with the transform coefficient to perform a structured mapping to determine a value for a level_ID syntax element and a value for a run syntax element based on the determined code number cn, and use the determined value for the level_ID syntax element and the determined value for the run syntax element to decode the block of video data.

### BRIEF DESCRIPTION OF DRAWINGS

FIG. 1 is a block diagram that illustrates one example of a video encoding and decoding system configured to operate according to the techniques of this disclosure.

FIG. 2 is a block diagram that illustrates one example of a video encoder configured to operate according to the techniques of this disclosure.

FIG. 3 is a block diagram that illustrates one example of a video decoder configured to operate according to the techniques of this disclosure.

FIG. 4 is a conceptual diagram that depicts one example of a scan of transform coefficients of video data consistent with one or more aspects of this disclosure.

FIG. 5 is a flow diagram that illustrates one example of a method of using variable length coding (VLC) to encode transform coefficients for one or more blocks of video consistent with one or more aspects of this disclosure.

FIG. 6 is a flow diagram that illustrates one example of a method of using variable length coding (VLC) to decode transform coefficients for one or more blocks of video consistent with one or more aspects of this disclosure.

FIG. 7 is a flow diagram that illustrates additional examples of methods of using variable length coding (VLC) to encode transform coefficients for one or more blocks of video consistent with one or more aspects of this disclosure.

### DETAILED DESCRIPTION

This disclosure describes techniques related to scanning transform coefficients during a video coding process. The technique can be applied by both video encoding and decoding units, including video encoder/decoders (CODECs) and processing units configured to perform video encoding and/or decoding. References to “video coding units” or “video coding devices” should be understood to refer to units or devices capable of encoding, decoding, or both encoding and decoding video data.

According to these techniques, an encoder can be configured to determine values associated with the transform coefficient (which are generally quantized to improve compressibility), map the determined values to a code number cn, and use the code number cn to access a VLC table. Based on the determined code number cn, the encoder outputs a VLC code word that represents the determined values.

In some examples, transform coefficients of a given block of a video frame are ordered (scanned) according to a zigzag scanning technique. Such a technique is used to generate a one-dimensional ordered coefficient vector. The zig-zag scanning begins at an upper leftmost coefficient of a block, and proceeding to scan in a zig-zag pattern to a lower rightmost coefficient of the block.

According to one example, a coder performs an inverse zig-zag scan. According to an inverse zig-zag scan, the coder begins coding at a location that corresponds to a last non-zero coefficient (e.g., a non-zero coefficient furthest from an upper left position of the block). Alternatively the encoder code in a zig-zag pattern as described above, but beginning in a bottom right position of the block and ending in an upper left position of the block.

Although many of the techniques of this disclosure will be described from the perspective of zig-zag scans (or inverse zig-zag scans), other scans (e.g., horizontal scans, vertical scans, combinations of horizontal, vertical and/or zig-zag scans, adaptive scans or other scans) could also be used to order the transform coefficients.

The quantized transform coefficients, as well as motion vectors describing relative motion between a block to be encoded and a reference block, can be referred to as “syntax elements.” Syntax elements, along with other control information, can be used to form a coded representation of the video sequence. In some examples, prior to transmission from an encoder to a decoder, syntax elements are entropy coded, thereby further reducing a number of bits needed for their representation. Entropy coding can be described as a lossless operation aimed at minimizing a number of bits required to represent transmitted or stored symbols (e.g., syntax elements) by utilizing properties of their distribution (e.g., some symbols occur more frequently than others).

One method of entropy coding employed by video coders is Variable Length Coding (VLC). According to VLC, a VLC codeword (a sequence of bits (0's and 1's)), are assigned to each symbol (e.g., syntax element). VLC codewords are constructed such that a length of the codeword corresponds to how frequently the symbol represented by the codeword occurs. For example, more frequently occurring symbols are represented by shorter VLC codewords. In addition, VLC codewords can be constructed such that the codewords are uniquely decodable. For example if a decoder receives a valid sequence of bits of a finite length, there could be only one possible sequence of input symbols that, when encoded, would produce the received sequence of bits.

For efficiency, the mapping of VLC codewords of a VLC table to symbols represented by the codewords is generally constructed such that a length of the codeword corresponds to how frequently the symbol represented by the codeword occurs. For example, more frequently occurring symbols are represented by shorter VLC codewords. In addition, VLC codewords can be constructed such that the codewords are uniquely decodable. For example if a decoder receives a valid sequence of bits of a finite length, there can be only one possible sequence of input symbols that, when encoded, would produce the received sequence of bits.

Generally a decoder receives a VLC codeword from an encoder. The decoder can access a VLC table (e.g., the same VLC table as encoder described above), and determine a code number for the VLC codeword. The decoder maps the determined code number cn to one or more values associated with the transform coefficient of video data. By using VLC codewords to signal, from an encoder to a decoder, one or more values associated with transform coefficients of a block of video data, an amount of data used to code (e.g., encode or decode) a block of video data is reduced.

In many embodiments, to determine a VLC codeword as described above, an encoder accesses a mapping table of a plurality of mapping tables that defines a mapping from the values run and level_ID to different values of code number cn. Such a mapping table can be selected by an encoder based on a position index value k of a current coefficient in the scan order. For example, a first such mapping table could be used for a position k equal to zero, and a second, different mapping table could be used for a position k equal to one. Position k could indicate a number of coefficients between a current coefficient and a last coefficient in an inverse scan order. Such a last coefficient could comprise a last coefficient in inverse zig-zag scan order. Again, although the techniques are described according to zig-zag and inverse zig-zag scans, similar techniques could apply to any scan order.

In the examples described herein, the code number cn typically represents an index within a VLC table in a plurality of VLC tables. In such examples, the encoder selects a VLC table from among a plurality of VLC tables based on a position of a current coefficient in scan order. Based on the code number cn, the encoder determines a VLC codeword using the selected VLC table. The encoder signals such a determined VLC codeword to a decoder. The decoder decodes a code number cn based on the received VLC codeword, and then uses the code number cn to determine the values of the run and level_ID syntax elements based on a current coefficient position. The decoder can use the determined values of run and level_ID to decode coefficients between a current coefficient and a next non-zero coefficient in scan order.

In some examples, storing a plurality of mapping tables is undesirable where an amount of memory resources available to the coder is limited. As such, it is often desirable to reduce a number of mapping tables stored in memory that are used to map between a code number cn and level_ID and run values.

According to one aspect of this disclosure, a coder maps values for run and level_ID to a code number cn based on a structured mapping (e.g., a mathematical relationship) as opposed to using a mapping table of a plurality of mapping tables as described. By using such a structured mapping, a number of mapping tables stored in a memory of the coder is thus reduced. Accordingly, memory resources that might have been used to store such a plurality of mapping tables become available for allocation to other purposes, and thereby improve a coding efficiency of the coder.

In some examples, such a structured mapping can be based on a position k of a transform coefficient. In other examples, such a structured mapping can also or instead be based on a most likely run value from a current coefficient to a next non-zero coefficient of the block of video data with a magnitude greater than one.

In some examples, such a structured mapping is based on at least one value stored in memory (e.g., an lrg1Pos value). According some aspects of this disclosure, the lrg1Pos is determined based on using at least one table that defines an lrg1Pos value for more than one potential noTr1 syntax element value for the scan order of the block of video data, thereby reducing the memory requirement for mapping tables stored to encode the data. In this and other examples, the decoding process benefits from the efficiency of the encoding method in an analogous manner.

According to other aspects of this disclosure, the mapping functions can be either static or adaptive. Adaptive functions either are changed in real time by the encoder in response to various parameters such as characteristics of the video stream or previously encoded transform coefficients associated with video block locations in a proximate region, or could be set by the user via an interface.

In one example, the same (static or adaptive) mapping function could be used for the entire stream of video data.

In another example, different (static or adaptive) mapping functions could be used for different units, blocks, or segments of the stream of video data.

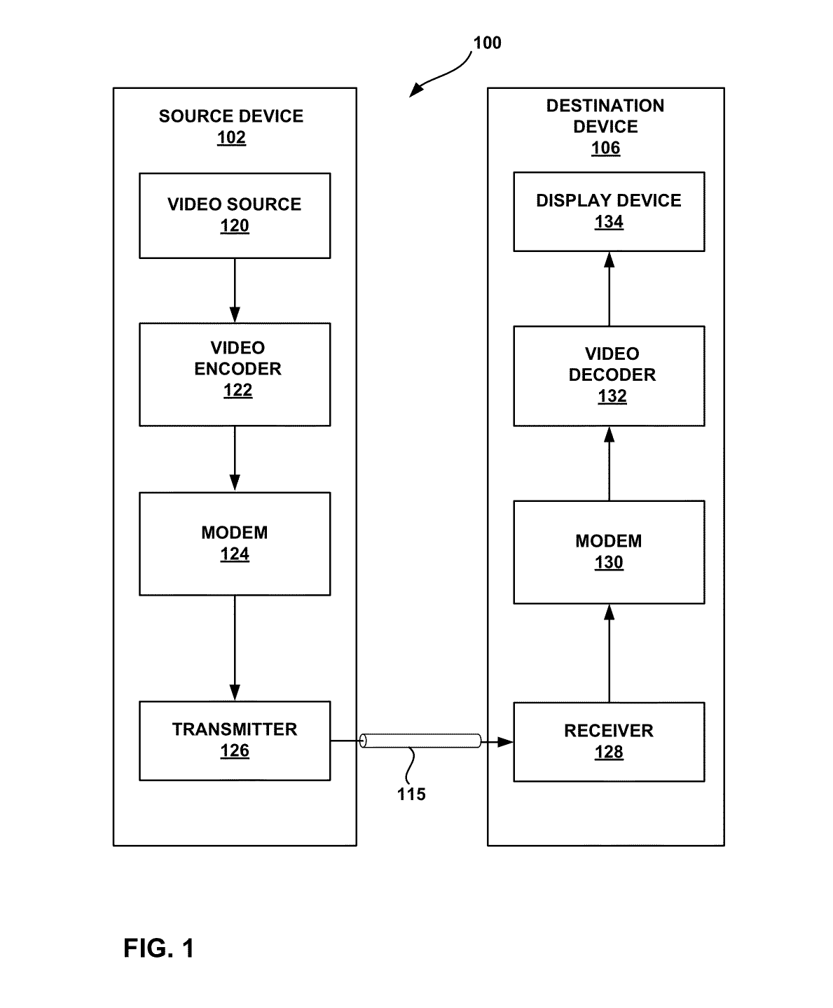

FIG. 1 is a block diagram illustrating an exemplary video encoding and a decoding system 100 that can be configured to implement techniques of this disclosure. As shown in FIG. 1, the system 100 includes a source device 102 that transmits encoded video to a destination device 106 via a communication channel 115. The source device 102 and the destination device 106 comprise any of a wide range of devices. In some cases, the source device 102 and the destination device 106 comprise wireless communication device handsets, such as so-called cellular or satellite radiotelephones. The techniques of this disclosure, however, which apply generally to the encoding and decoding transform coefficients of video data, are not necessarily limited to wireless applications or settings, and are potentially applicable to a wide variety of non-wireless devices that include video encoding and/or decoding capabilities.

In the example of FIG. 1, the source device 102 includes a video source 120, a video encoder 122, a modulator/demodulator (modem) 124 and a transmitter 126. The destination device 106 includes a receiver 128, a modem 130, a video decoder 132, and a display device 134. In accordance with this disclosure, the video encoder 122 of the source device 102 scans transform coefficients of a block of video data that includes a two-dimensional matrix of transform coefficients (e.g., that each corresponds to pixels of a displayed image) into a one-dimensional vector that represents the transform coefficients. According to some embodiments of this disclosure, the video encoder 122 adaptively scans a first plurality of the coefficients of the block of video data, and uses a fixed scan for a second plurality of coefficients of the block. For example, for the first plurality of transform coefficients, the video encoder 122 adaptively modifies an order in which the first plurality of transform coefficients are scanned, relative to an order in which transform coefficients of at least one previously encoded block of video data were scanned. For example, the video encoder 122 modifies the order in which transform coefficients are scanned, based on a how often coefficients at the same position in other previously encoded blocks are non-zero coefficients. For the second plurality of transform coefficients, the video encoder 122 does not adaptively modify an order in which the second plurality of transform coefficients are scanned, relative to a scan order of at least one previously encoded block of video data. Instead, the video encoder 122 scans the second plurality of coefficients using a same scan order, for a plurality of blocks of video data encoded by the encoder.

The video decoder 132 of the destination device 106 can also be configured to perform reciprocal transform coefficient decoding. Under those circumstances, the video decoder 132 maps coefficients of a one-dimensional vector of transform coefficients that represent a block of video data to positions within a two-dimensional matrix of transform coefficients, to reconstruct the two-dimensional matrix of transform coefficients.

The illustrated system 100 of FIG. 1 is merely exemplary. The transform coefficient encoding and decoding techniques of this disclosure can be performed by any encoding or decoding devices. The source device 102 and the destination device 106 are merely examples of coding devices that can support such techniques.

In this example, the video encoder 122 of the source device 102 encodes video data received from the video source 120. The video source 120 comprises a video capture device, such as a video camera, a video archive containing previously captured video, or a video feed from a video content provider. As a further alternative, the video source 120 optionally generates computer graphics-based data as the source video, or a combination of live video, archived video, and computer-generated video. In some cases, if the video source 120 is a video camera, the source device 102 and the destination device 106 form so-called camera phones or video phones. In each case, the captured, pre-captured or computer-generated video is encoded by the video encoder 122.

In the exemplary system 100, once the video data is encoded by the video encoder 122, the encoded video information is modulated by the modem 124 according to a communication standard, e.g., such as code division multiple access (CDMA) or any other communication standard or technique, and transmitted to the destination device 106 via the transmitter 126. The modem 124 includes various mixers, filters, amplifiers or other components designed for signal modulation. The transmitter 126 of this example includes circuits designed for transmitting data, including amplifiers, filters, and one or more antennas. The receiver 128 of the destination device 106 receives information over the channel 115, and the modem 130 demodulates the information. Again, the video decoding process performed by the video decoder 132 includes similar (e.g., reciprocal) decoding techniques to the encoding techniques performed by the video encoder 122.

According so some aspects of this disclosure, the communication channel 115 comprises any wireless or wired communication medium, such as a radio frequency (RF) spectrum or one or more physical transmission lines, or any combination of wireless and wired media. In such instances the communication channel 115 forms part of a packet-based network, such as a local area network, a wide-area network, or a global network such as the Internet. The communication channel 115 generally represents any suitable communication medium, or a collection of different communication media, for transmitting video data from the source device 102 to destination device 106.

Again, FIG. 1 is merely exemplary and the techniques of this disclosure are applicable to video coding settings (e.g., video encoding or video decoding) that do not necessarily include any data communication between the encoding and decoding devices. In other examples, data could be retrieved from a local memory, streamed over a network, or the like. An encoding device encodes and store data to memory, and/or a decoding device retrieves and decodes data from memory. In many cases the encoding and decoding is performed by unrelated devices that don't communicate with one another, but simply encode data to memory and/or retrieve and decode data from memory.

Although not shown in FIG. 1, in some aspects, the video encoder 122 and the video decoder 132 could each be integrated with an audio encoder and decoder, and optionally include appropriate MUX-DEMUX units, or other hardware and software, to handle encoding of both audio and video in a common data stream or separate data streams. If applicable, MUX-DEMUX units could conform to the ITU H.223 multiplexer protocol, or other protocols such as the user datagram protocol (UDP).

Either or both of the video encoder 122 and the video decoder 132 can be implemented as one or more microprocessors, digital signal processors (DSPs), application specific integrated circuits (ASICs), field programmable gate arrays (FPGAs), discrete logic, software, hardware, firmware or any combinations thereof. Each of the video encoder 122 and the video decoder 132 is potentially included in one or more encoders or decoders, either of which is potentially integrated as part of a combined encoder/decoder (CODEC) in a respective mobile device, subscriber device, broadcast device, server, or the like.

In some cases, the devices 102, 106 can be configured to operate in a substantially symmetrical manner. For example, each of the devices 102, 106 optionally includes video encoding and decoding components. Hence, the system 100 could support one-way or two-way video transmission between the video devices 102, 106, e.g., for video streaming, video playback, video broadcasting, or video telephony.

During the encoding process, the video encoder 122 executes a number of coding techniques or operations. In general, the video encoder 122 operates on video blocks within individual video frames (or other independently coded units such as slices) in order to encode the video blocks. Frames, slices, portions of frames, groups of pictures, or other data structures can be defined as independent data units that include a plurality of video blocks, and syntax elements can be included at such different independent data units. The video blocks within independent data units can have fixed or varying sizes, and possibly differ in size according to a specified coding standard. In some cases, each video frame includes a series of independently decodable slices, and each slice can additionally include one or more macroblocks or LCUs.

Macroblocks are one type of video block defined by the ITU H.264 standard and other standards. Macroblocks typically refer to 16 by 16 blocks of data. The ITU-T H.264 standard supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. For example, whereas ITU-T H.264 provides nine intra-prediction modes, HM provides at least thirty-four intra-prediction modes.

The emerging HEVC standard defines new terms for video blocks. In particular, with HEVC, video blocks (or partitions thereof) are permissibly referred to as “coding units.” With the HEVC standard, largest coding units (LCUs) is divided into smaller and smaller coding units (CUs) according to a quadtree partitioning scheme, and the different CUs that are defined in the scheme are can be further partitioned into so-called prediction units (PUs) and/or transform units (TUs). The LCUs, CUs, and PUs, and TUs are all video blocks within the meaning of this disclosure. Other types of video blocks could potentially also be used, consistent with the HEVC standard or other video coding standards. Thus, the phrase “block” refers to any size of video block. Moreover, video blocks sometimes refer to blocks of video data in the pixel domain, or blocks of data in a transform domain such as a discrete cosine transform (DCT) domain, a domain similar to DCT, a wavelet domain, or the like. In addition, a block of data as described herein could refer to a luma block, subsampled chroma block, or both a luma block and two sub-sampled chroma blocks.

Referring again to FIG. 1, the video encoder 122 often performs predictive coding in which a video block being coded is compared to another block of video data in order to identify a predictive block. This process of predictive coding is often referred to as motion estimation and motion compensation. Motion estimation estimates video block motion relative to one or more predictive video blocks of one or more predictive frames (or other coding units). Motion compensation generates the desired predictive video block from the one or more predictive frames or other coding units. Motion compensation includes an interpolation process in which interpolation filtering is performed to generate predictive data at fractional pixel precision.

After generating the predictive block, the differences between the current video block being coded and the predictive block are coded as a residual block, and prediction syntax (such as a motion vector) is used to identify the predictive block. The residual block is transformed and quantized. Transform techniques optionally comprises a DCT process or conceptually similar process, integer transforms, wavelet transforms, or other types of transforms. In a DCT or DCT-like process, as an example, the transform process converts a set of pixel values (e.g., residual values) into transform coefficients, which for instance represent the energy of the pixel values in the frequency domain. Quantization is typically applied on the transform coefficients, and generally involves a process that limits the number of bits associated with any given transform coefficient.

In many embodiments, following transform and quantization, entropy coding is performed on the transformed and quantized residual video blocks. Syntax elements, various filter syntax information, and prediction vectors defined during the encoding are included in the entropy-coded bitstream. In general, entropy coding comprises one or more processes that collectively compress a sequence of quantized transform coefficients and/or other syntax information. Scanning techniques, such as fixed or adaptive scan orders, are performed on the quantized transform coefficients in order to define one or more serialized one-dimensional vectors of coefficients from two-dimensional video blocks. For example, according to the techniques described herein, both fixed and adaptive scan techniques can be used, for different coefficients of a video block. Once scanned to generate the one or more serialized one-dimensional vectors, the scanned coefficients are then entropy coded along with any syntax information.

As part of the encoding process, encoded video blocks are decoded to generate the video data used for subsequent prediction-based coding of subsequent video blocks. At this stage, filtering is can be employed in order to improve video quality, and e.g., remove blockiness or other artifacts from decoded video. This filtering is optionally in-loop or post loop. With in-loop filtering, the filtering of reconstructed video data occurs in the coding loop, which means that the filtered data is stored by an encoder or a decoder for subsequent use in the prediction of subsequent image data. In contrast, with post-loop filtering, the filtering of reconstructed video data occurs out of the coding loop, which means that unfiltered versions of the data are stored by an encoder or a decoder for subsequent use in the prediction of subsequent image data.

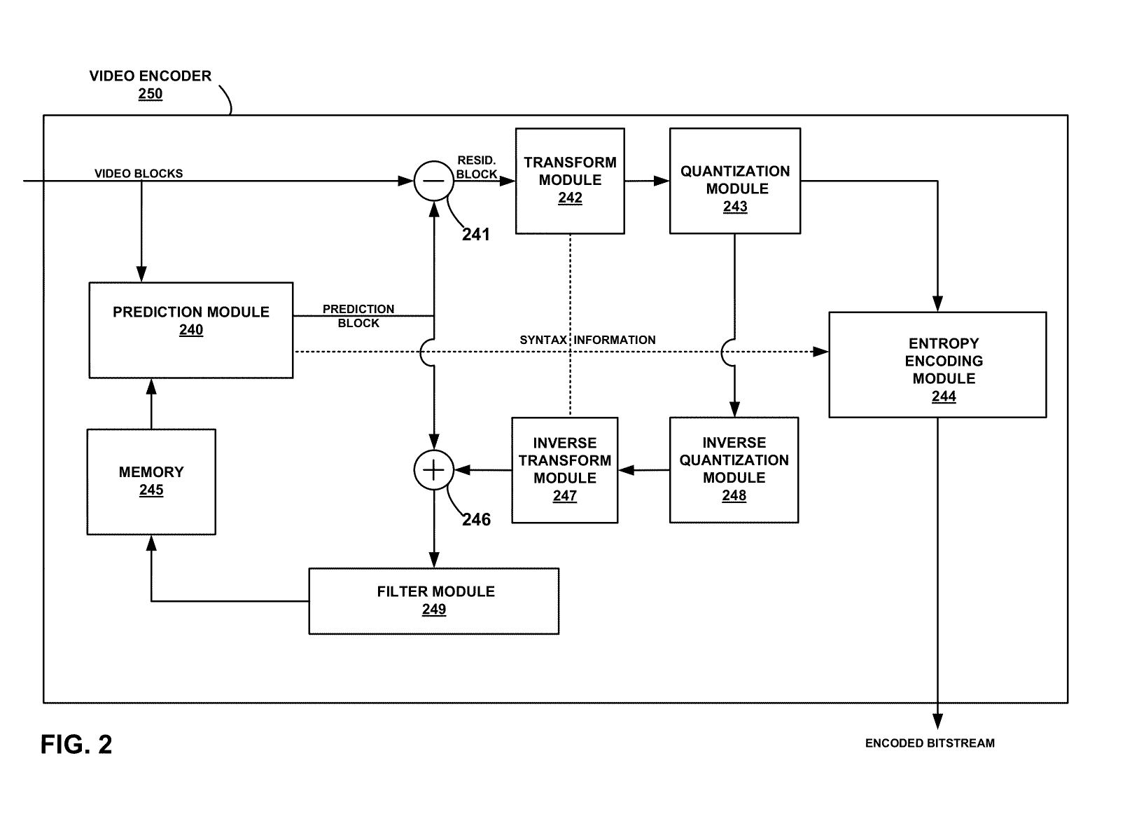

FIG. 2 is a block diagram illustrating an example video encoder 250 consistent with this disclosure. The video encoder 250 could either correspond to the video encoder 122 of the source device 100, or a video encoder of a different device. As shown in FIG. 2, the video encoder 250 includes a prediction module 240, adders 241 and 246, and a memory 245. The video encoder 250 also includes a transform module 242 and a quantization module 243, as well as an inverse quantization module 248 and an inverse transform module 247. The video encoder 250 also includes an entropy coding module 244. The entropy coding module 244 includes a scan module 260.

During the encoding process, the video encoder 250 receives a video block to be coded, and the prediction module 240 performs predictive coding techniques. For inter coding, the prediction module 240 compares the video block to be encoded to various blocks in one or more video reference frames or slices in order to define a predictive block. For intra coding, the prediction module 240 generates a predictive block based on neighboring data within the same frame, slice, or other unit of video data. The prediction module 240 outputs the prediction block and the adder 241 subtracts the prediction block from the video block being coded in order to generate a residual block.

According to some aspects of this disclosure, for inter coding, the prediction module 240 comprises motion estimation and motion compensation modules (not depicted in FIG. 2) that identify a motion vector that points to a prediction block and generates the prediction block based on the motion vector. Typically, motion estimation is considered the process of generating the motion vector, which estimates motion. For example, the motion vector could indicate the displacement of a predictive block within a predictive frame relative to the current block being coded within the current frame. Motion compensation is typically considered the process of fetching or generating the predictive block based on the motion vector determined by motion estimation. For intra coding, the prediction module 240 generates a predictive block based on neighboring data within the same frame, slice, or other unit of video data. One or more intra-prediction modes could potentially define how an intra prediction block can be defined.

In some examples, motion compensation for inter-coding includes interpolations to sub-pixel resolution. Interpolated predictive data generated by the prediction module 240, for example, is interpolated to half-pixel resolution, quarter-pixel resolution, or even finer resolution. This permits motion estimation to estimate motion of video blocks to such sub pixel resolution.

After the prediction module 240 outputs the prediction block, and after the adder 241 subtracts the prediction block from the video block being coded in order to generate a residual block, the transform module 242 applies a transform to the residual block. The transform optionally comprises a discrete cosine transform (DCT), an integer transform, or a conceptually similar transform such as that defined by the ITU H.264 standard, the HVEC standard, or the like. In some examples, the transform module 242 performs differently sized transforms and selects different sizes of transforms for coding efficiency and improved compression. Wavelet transforms, integer transforms, sub-band transforms or other types of transforms could also be used. In any case, the transform module 242 applies a particular transform to the residual block of residual pixel values, producing a block of residual transform coefficients. The transform converts the residual pixel value information from a pixel domain to a frequency domain.

The inverse quantization module 248 and the inverse transform module 247 apply inverse quantization and inverse transform, respectively, to reconstruct the residual block in the pixel domain. The summer 246 adds the reconstructed residual block to the prediction block produced by the prediction module 240 to produce a reconstructed video block for storage in the memory 245. The filter module 249 possibly performs in-loop or post loop filtering on reconstructed video blocks.

In some examples, the memory 245 stores a frame or slice of blocks for use in motion estimation with respect to blocks of other frames to be encoded. Prior to such storage, in the case of in-loop filtering, the filter module 249 applies filtering to the video block to improve video quality. Such filtering by the filter module 249 reduces blockiness or other artifacts. Moreover, filtering improves compression by generating predictive video blocks that comprise close matches to video blocks being coded. Filtering can also be performed post-loop such that the filtered data is output as decoded data, but unfiltered data is used by the prediction module 240.

In certain examples, the quantization module 243 quantizes the residual transform coefficients (e.g., from the transform module 242) to further reduce bit rate. The quantization module 243, for example, limits the number of bits used to code each of the coefficients. After quantization, the entropy encoding module 244 scans and entropy encodes the data. For example, the entropy encoding module 244 could scan the quantized coefficient block from a two-dimensional representation to generate one or more serialized one-dimensional vectors. For example, the scan module 260 could perform a scan of a two-dimensional matrix that represents a quantized coefficient block.

Following this scanning process, the entropy encoding module 244 encodes the quantized transform coefficients (along with any syntax elements) according to an entropy coding methodology as described herein to further compress the data. In this example, syntax information included in the entropy encoded bitstream includes prediction syntax from the prediction module 240, such as motion vectors for inter coding or prediction modes for intra coding. Syntax information included in the entropy encoded bitstream possibly also includes filter information, such as that applied for interpolations by the prediction module 240 or filters applied by the filter module 249. In addition, syntax information included in the entropy coded bitstream can also includes one or more VLC code words that represent one or more of syntax elements (or other information).

Following the entropy coding by the entropy encoding module 244, the encoded video is transmitted to another device or archived for later transmission or retrieval. For example, a decoder could use a one-dimensional vector of transform coefficients of the encoded video, generated by entropy the encoding module 244, to reconstruct a two-dimensional matrix that represents a block of video data.

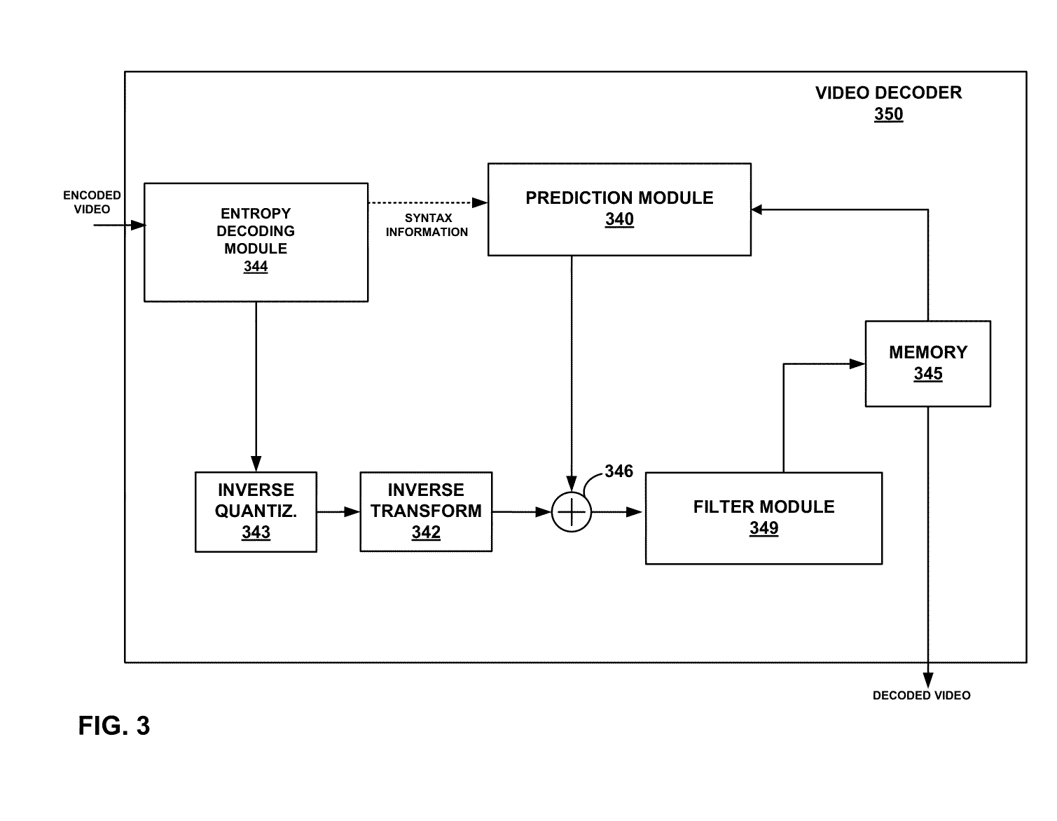

FIG. 3 is a block diagram illustrating an example of a video decoder 350, which decodes a video sequence that is encoded in the manner described herein. The received video sequence optionally comprises an encoded set of image frames, a set of frame slices, a commonly coded group of pictures (GOPs), or a wide variety of coded video units that include encoded video blocks and syntax information to define how to decode such video blocks.

The video decoder 350 represented in FIG. 3 incorporates an entropy decoding module 344 that performs the decoding function that is the reciprocal of the encoding performed by the entropy encoding module 244 of FIG. 2. In some examples, the entropy decoding module 344 converts entropy encoded video blocks in a one-dimensional serialized format back into a two-dimensional block format. The number and size of the vectors, as well as the scan order defined for the video blocks, define how the two-dimensional block is reconstructed.

As depicted in FIG. 3, the video decoder includes a filter module 349. The filter module 349 could perform in-loop or post loop filtering on reconstructed video blocks. The video decoder 350 also includes a prediction module 340, an inverse quantization unit 343, an inverse transform module 342, a memory 345, and a summer 346.

A wide variety of video compression technologies and standards perform spatial and temporal prediction to reduce or remove the redundancy inherent in input video signals. As explained above, an input video block is predicted using spatial prediction (i.e., intra prediction) and/or temporal prediction (i.e., inter prediction or motion estimation). The prediction modules described herein generally include a mode decision module (not shown) in order to choose a desirable prediction mode for a given input video block. Mode selection considers a variety of factors such as whether the block is intra or inter coded, the prediction block size and the prediction mode if intra coding is used, and the motion partition size and motion vectors used if inter coding is used. A prediction block is subtracted from the input video block, and transform and quantization are then applied on the residual video block as described above.

The quantized coefficients, along with the mode information, can be entropy encoded to form a video bitstream. The quantized coefficients also can be inverse quantized and inverse transformed to form the reconstructed residual block, which can be added back to the prediction video block (intra predicted block or motion compensated block depending on the coding mode chosen) to form the reconstructed video block. In loop or post-loop filtration methods are applicable to reduce the visual artifacts in the reconstructed video signal. The reconstructed video block is finally stored in the reference frame buffer (i.e., memory) for use of coding of future video blocks.

In some examples, coefficients of given leaf level block of a video frame is ordered (scanned) according to a zigzag scanning technique. Such a technique is used by the encoder 250 to generate a one-dimensional ordered coefficient vector. A zig-zag scanning technique comprises beginning at an upper leftmost coefficient of the block, and proceeding to scan in a zig-zag pattern to the lower leftmost coefficient of the block.

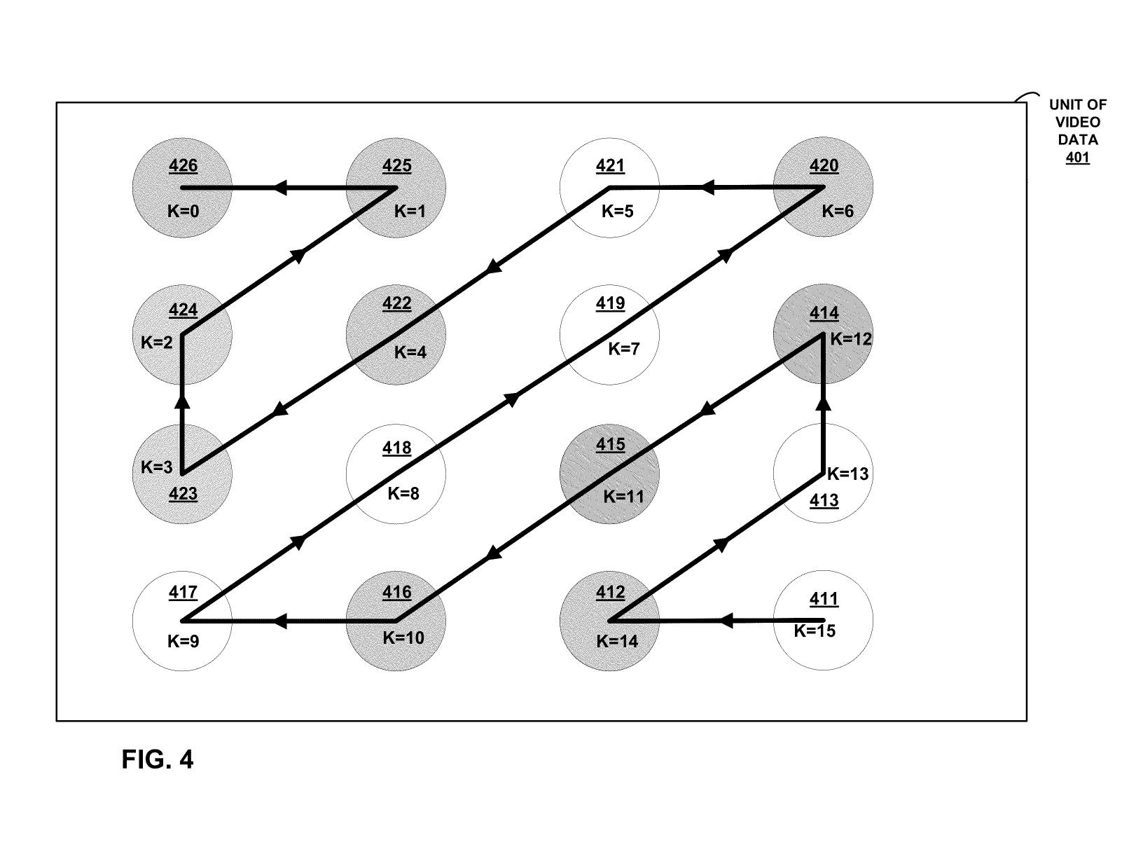

FIG. 4 is a conceptual diagram that depicts one example of a scan of transform coefficients of a leaf-level unit 401 of video data consistent with one or more aspects of this disclosure. The techniques of FIG. 4 are described as performed by the video encoder 250 depicted in FIG. 2, however any device, such as the video decoder 350 depicted in FIG. 3, can alternatively used to perform the techniques of FIG. 4.

As shown in FIG. 4, the leaf-level unit 401 includes a plurality of transform coefficients 411-426 that are each arranged at positions in a two-dimensional matrix. According to the example of FIG. 4, the leaf-level unit 401 comprises any arrangement of video data for which by the encoder 250 performs a scan of transform coefficients. For example, the leaf-level unit 401 comprises an undivided coding unit, such as a transform leaf-node transform unit (TU) as described above.

The example of FIG. 4 shows an inverse zig-zag scan of a leaf-level coding unit 401 that includes sixteen transform coefficients (e.g., a 4×4 coding unit). According to other examples, by the encoder 250 applies the techniques described herein to larger, or smaller, coding units. In addition, although FIG. 4 depicts an inverse zig-zag scan of transform coefficients, the techniques described herein is applicable to any scan order including any combination of horizontal scans, vertical scans, non-inverse zig-zag scan, or even adaptively-defined or adjustable scans.

According to the techniques described herein, by the encoder 250 begins coding transform coefficients of the leaf-level unit 401 at a last non-zero coefficient 412 of the coding unit 401 according to the inverse zig-zag scan. In this example, the last non-zero coefficient of the coding unit 401 can also be described as a first coefficient of the inverse zig-zag scan that has a magnitude greater than zero.

According to the example of FIG. 4, after coding the last non-zero coefficient 412, the encoder 250 generates a run syntax element that indicates how many zero value coefficients (one, coefficient 413 in the example of FIG. 4) are between the coefficient 412 and a next non-zero coefficient (coefficient 414 in the example of FIG. 4) in the order of the scan. In the run mode, the encoder 250 also generates a level_ID syntax element that indicates whether the coefficient has a value of 1, or greater than one, as described above.

According to a zigzag scanning technique, it is presumed that transform coefficients having a greatest energy (e.g., a greatest coefficient value) correspond to low frequency transform functions and is located towards a top-left of a block. As such, for a coefficient vector (e.g., one-dimensional coefficient vector) produced based on zigzag scanning, higher magnitude coefficients are assumed to be most likely to appear toward a start of the vector. It is also assumed that, after a coefficient vector has been quantized, most low energy coefficients will be equal to 0. In some examples, coefficient scanning is adapted during coefficient coding. For example a lower number in the scan is assigned to positions for which non-zero coefficients happen more often.

According to some examples, the encoder 250 performs an inverse zig-zag scan of transform coefficients. According to an inverse zig-zag scan, the encoder 250 begins encoding at a location that corresponds to a last non-zero coefficient (e.g., a non-zero coefficient furthest from an upper left position of the block). Unlike the example of a zigzag scan described above, according to the example of an inverse zig-zag scan, the encoder 250 codes in a zigzag pattern from the last non-zero coefficient (i.e., in a bottom right position of the block) to an upper left position of the block. In some examples, the encoder 250 is configured to switch between a run coding mode and a level mode of coding based on a magnitude of one or more already coded coefficients.

According to a run encoding mode example, if a coefficient has a magnitude greater than zero, the encoder 250 signals a level_ID syntax element for the scanned coefficient. The level_ID syntax element could indicate whether the coefficient has amplitude of 1 or greater than 1. For example, the encoder 250 could assign level_ID a value of zero (0) if the coefficient has a magnitude equal to one (1). However, if coefficient has a value greater than one (1), the encoder 250 could assign level_ID a value of one (1). In some examples, if level_ID has a value of one, the encoder could also signal a level syntax element that indicates a magnitude of the transform coefficient.

To begin coding a block of video data using the run coding mode, the encoder 250 can first signal a last_pos syntax element, which indicates a position of a last non-zero coefficient (according to a zig-zag scan order, first coefficient of an inverse zig-zag scan order) of the scan. The encoder 250 can also signal a level_ID syntax element that indicates whether the last non-zero coefficient of the scan has a value of one (1) or greater than one, as described above. After the encoder 250 has signaled the last_pos syntax element and the level_ID syntax element associated with the last_pos syntax element, the encoder 250 can signal a run syntax element and a level_ID syntax element associated with one or more other coefficients of the scan.

The run syntax element indicates a number of coefficients with amplitude close to or equal to zero between a current (encoded) coefficient and a next non-zero coefficient in the scanning order. According to one example, the run syntax element can have a value in a range from zero to k+1, where k is a position of the current non-zero coefficient.

In some examples, to determine a VLC code word that represents run and level_ID syntax elements, the encoder 250 first determines values for the run and level_ID syntax elements, and use the determined values to determine a code number cn. The encoder 250 then uses the determined code number cn to determine the VLC code word.

In some examples, to determine the code number cn based on the determined values for the level_ID and run syntax elements, encoder 250 uses a mapping table of a plurality of mapping tables stored in memory that defines a relationship between the level_ID and run syntax elements, and the code number cn. Such a mapping table defines, for each possible combination of values for the level_ID and run syntax elements, a code number that corresponds to each of the respective level_ID and run syntax elements. According to these examples, the encoder 250 inputs determined level_ID and run syntax element values to into a selected mapping table, to determine the code number cn.

In some examples, storing such one or more mapping tables (e.g., by an encoder and/or a decoder) as described above is undesirable, especially where there are many potential values for the level_ID and/or the run syntax element. According some examples, the encoder 250 uses a structured mapping instead of such a mapping table of a plurality of mapping tables to determine the code number cn based on determine level_ID and run values. According to these examples, the structured mapping is performed based on a mathematical relationship between the level_ID and run syntax elements and the code number cn.

According to one example of such a structured mapping, the encoder 250 determines a value noTr1. The noTr1 value indicates a number of consecutive transform coefficients encoded by the encoder that have a magnitude equal to one. The noTr1 value is described as a counter that counts a number of consecutive coefficients with a magnitude equal to one. For example, as transform coefficients are coded, if a particular coefficient has a magnitude equal to one, the encoder 250 increments the noTr1 value by one. However, if a particular coefficient has a magnitude of greater than one (e.g., 2, 3, or 4), then the encoder 250 resets the value of noTr1 to zero.

In some examples, a mathematical relationship used to perform a structured mapping between determined level_ID and run syntax elements and a code number cn is defined at least in part based on a value lrg1Pos. In one embodiment, lrg1Pos is determined by the encoder 250 based on a determined noTr1 value associated with a transform coefficient, as well as a position k for the transform coefficient. Once a value lrg1Pos has been determined by the encoder 250, the encoder 250 applies the mathematical relationship, to determine the code number cn based on the determined level_ID and run values. Example 1 below is one example of pseudo code that can be used by an encoder to perform a structured mapping, as described herein.

### Example 1

if (level_ID==0)
{

if (run< lrg1Pos)

cn=run;

else

cn=2*run− lrg1Pos +1;

}
else{

if (run>(k− lrg1Pos +1))

cn=k+run+2;

else

cn=lrg1Pos+2*run;

}

According to the example pseudo code above, if level_ID is equal to zero, and if a value of run is less than the value lrg1Pos, then the encoder 250 assigns the code number a value of the run syntax element. However, if a value of run is greater then or equal to lrg1Pos, then the encoder 250 assigns the code number cn a value equal to two times a value of run minus a value of lrg1Pos plus 1. If a value of level_ID is equal to 1, and run is greater than a value k− lrg1Pos +1, then the encoder 250 assigns the code number cn a value equal to k plus run plus 2. However, if a value of run is less than or equal to k− Irg1Pos +1 the encoder 250 assigns the code number cn a value of lrg1Pos plus two times a value of run.

As described above, to perform the structured mapping described above, the encoder 250 first determines the noTr1 value, and use noTr1 value in addition to a position k of the transform to determine the lrg1Pos. As described with respect to the pseudo code of Example 1, the encoder 250 then performs a structured mapping using the determined lrg1Pos value, to determine the coder number cn based on the determined level_ID and run values.

According to the examples described above, the encoder 250 determines an lrg1Pos value based on determined noTr1 and a position k of a transform coefficient by using a table that defines a relationship between the determined noTr1 value, the position k, and the lrg1Pos value. For example, such a table could define, for each possible combination of values for noTr1 and position k, an independent value of lrg1Pos. Below is one example of such a table that defines lrg1Pos values for each of a plurality of different combinations of values for position k and noTr1.

TABLE 1
lrg1Pos values

| | k = | k = | k = | k = | k = | k = | k = | | k = |
|---|---|---|---|---|---|---|---|---|---|
| | 0 | 1 | 2 | 3 | 4 | 5 | 6 | . . . | N |
| noTr1 = 0 | a | b | c | d | e | f | g | h | i |
| noTr1 = 1 | j | k | l | m | n | o | p | q | s |
| noTr1 = 2 | aa | ab | ac | ad | ae | af | ag | ah | ai |
| noTr1 = 3 | aj | ak | al | am | an | ao | ap | aq | as |
| noTr1 = 4 | ba | bb | bc | bd | be | bf | bg | bh | bi |

As shown in Table 1 above, according to the examples described above, the encoder 250 is configured to store a table that defines, for each possible combination of noTr1 value and position k value, up to N, which represents a number of coefficients of a scan, an independent value for lrg1Pos. According to examples where the encoder 250 uses a structured as described above to determine a code number that represents run and level_ID values for a transform coefficient, the encoder 250 inputs a determined noTr1 value and a position k for a transform coefficient into a table such as Table 1 above to determine an lrg1Pos value. The encoder 250 uses the lrg1Pos value from the table to then determine the code number cn, for example by applying the structured mapping such as the structured mapping of Example 1, to determine the code number cn. The encoder 250 then inputs the determined code number cn into a VLC table of a plurality of VLC tables stored in memory, to determine a VLC code word that represents the level_ID and run values. The encoder 250 uses the VLC code word to signal, to a decoder, the level_ID and run syntax elements, as part of an entropy encoded bit stream of video data. The decoder 350 applies inverse techniques to those described above, to determine the coded level_ID and run syntax element values, from the VLC code word. For example, the decoder 350 uses a VLC code word ready from an entropy encoded bit stream to determine a code number cn, and use the determined code number cn to determine level_ID and run syntax element values using the inverse of the techniques described above.

In some examples, storing a table that defines an lrg1Pos value for each potential value of noTr1 and position k for a transform coefficient consumes a relatively large amount of memory resources. Storing such a table is undesirable in real world instances where an amount of memory accessible by a coder (e.g., the encoder 250 and/or the decoder 350) is limited.

This disclosure describes techniques that can be effectively used to reduce an amount of memory used by the coder 250, 350 to code level_ID and run syntax elements using a structured mapping as described above, to determine a code number cn that represents level_ID and run syntax elements associated with a transform coefficient of a block of video data. According to aspects of this disclosure, the coder 250, 350 is configured to, instead of using a table that defines an lrg1Pos value for each possible combination of noTr1 and position k, use a table that defines the same lrg1Pos value, for multiple different potential values for noTr1. To use the table, the coder 250, 350 uses a mapping function F( ) to access the table, as described in further detail below.

To use a same lrg1Pos value for multiple different potential values of noTr1, the coder 250, 350 can store a table that defines at least two potential sets of values for lrg1Pos, that each correspond to more than one potential noTr1 value, for respective potential positions k of a transform coefficient of a scan, defining a new mapping function F′(lrg1Pos,k). For example, such a table includes a plurality of columns each dedicated to potential values of position k, and first and second rows that are each dedicated to an output value of a mapping function F( ) that receives as an input a determined noTr1 value. For example, the coder 250, 350 could store a table such as Table 2 codifying F′( ), reproduced below.

TABLE 2
lrg1Pos values

| | k = | K = | k = | k = | k = | k = | k = | | k = |
|---|---|---|---|---|---|---|---|---|---|
| | 0 | 1 | 2 | 3 | 4 | 5 | 6 | . . . | N |
| F(noTr1) = 0 | a | b | c | d | e | f | g | h | i |
| F(noTr1) = 1 | j | k | l | m | n | o | p | q | s |

According to the example of Table 2 above, to determine an lrg1Pos value a-q for a transform coefficient, the coder 250, 350 first determines a noTr1 value for the transform coefficient. The coder 250, 350 inputs the determined noTr1 value into the mapping function F( ), which returns an indication of whether the encoder should use the first row of Table 2 to determine the lrg1Pos value based on a position k for the transform coefficient, or use the second row of Table 2 to determined the lrg1Pos value based on the position k.

In various embodiments, such a mapping function F( ) is used to determine which of a plurality of potential values of noTr1 correspond to the respective first and second rows of Table 2 set forth above. For example, referring back to the example of Table 2 discussed above, for a particular scan of transform coefficients, there are five (5) potential values for noTr1 (noTr1=0-4). The mapping function is used to define which of the five potential values for noTr1 are associated with the first row of Table 2, and which of the five potential values for noTr1 are associated with the second row of Table 2. According to one specific example, such a mapping function F( ) defines that, for potential noTr1 values of 0 and 4, the coder accesses the first row of Table 2 (e.g., F(noTr1)=0). According to this example, such a mapping function F( ) also defines that, for potential noTr1 values of 1-3, the coder accesses the second row of Table 2 (e.g., F(noTr1)=0).

Example 2 below is one example of pseudo code that can be used by a coder to implement a mapping function F( ) as described above:

if (noTr1 == 0 ∥ noTr1 == 4)

lrg1Pos = Lrg1Pos[0][k];

else if (noTr1 == 1 ∥ noTr1 == 2 ∥ noTr1 == 3)

lrg1Pos = Lrg1Pos[1][k];

According to the example of a mapping function described above, if a value of noTr1 is equal to zero or four, lrg1Pos is assigned a value by inputting a position k of a transform coefficient into a first row (row 0) of a table Lrg1Pos_Table. However, if noTr1 has a value of 1, 2, or 3, the coder 250, 350 my assign lrg1Pos a value by inputting a position k of the transform coefficient into a second row (row 0) of the table Lrg1Pos_Table. According to this example, the coder 250, 350 is configured to determine an lrg1Pos value using a table such as Table 2 above that defines the same lrg1Pos value, for a plurality of different potential values for noTr1. In this manner, the coder 250, 350 can be configured to perform a structured mapping to determine a code number cn from determined level_ID and run syntax elements for a transform coefficient, while consuming less memory to perform the structured mapping in comparison to other techniques because, as shown by the example of Table 2 above, a table used to define the lrg1Pos value based on noTr1 and position k is smaller (i.e., consume less memory), than other techniques, such as using a table such as Table 1 set forth above.

The example of Table 2 described above is merely one example of such a table that defines a mapping F( ) between more than one noTr1 value and a single lrg1Pos value, for different positions k of a transform coefficient scan. For example, Table 2 includes two rows, or two potential output values of the mapping function F( ) of Example 2 above. In other examples, the table can have more than two rows, and the mapping function could have a corresponding number of different output values. Any size table that defines a mapping between more than one potential noTr1 value and a single lrg1Pos value can be used according to the techniques described herein.

As described above, according to the techniques of this disclosure the coder 250, 350 can employ a mapping function to select one of the first or second rows of values for lrg1Pos depicted in Table 2 above. In some examples, the coder 250, 350 stores such a mapping function in memory, and access the stored mapping function to determine lrg1Pos values when needed. In other examples consistent with the techniques described herein, the encoder 250 signals such a mapping function, and the decoder 350 can read such a signaled mapping function (e.g., signaled by the encoder 250, a user, or other source). For example, the encoder 250 could signal such a mapping function in header information of an entropy encoded bit stream. According to these example, the decoder 350 uses the signaled mapping function, to determine one or more lrg1Pos values for a transform coefficient. In some examples, the encoder 250 could signal such a mapping function in header information for a frame of video data, such as a picture parameter set (PPS) of an entropy encoded bit stream. In other examples, the encoder 250 signals such a mapping function in header information for a slice of video data of a frame, such as a slice parameter set (SPS) of an entropy encoded bit stream. In still other examples, the encoder 250 could signal such a mapping function in header information for a block of video data of a slice or frame.

According to the examples described above, according to the techniques of this disclosure, the coder 250, 350 determines an lrg1Pos value associated with a transform coefficient based on a noTr1 value associated with the transform coefficient, as well as a position k for the transform coefficient. In other examples consistent with the techniques described herein, the coder 250, 350 also or instead determines an lrg1Pos value associated with a transform coefficient based on other information associated with a block, slice, or frame of video data. Examples of such other information include one or more of a prediction type (e.g., intra or inter coded prediction type), color component (e.g., luma or chroma), motion partition (e.g., 2N×N, N×2N or 2N×2N), motion partition size, transform block size, quantization parameters, motion vector amplitude, motion vector predictions, or any other information associated with a frame, slice, and/or block of video data.

For example, the coder 250, 350 can be configured to select a first table that defines an lrg1Pos values for more than one potential noTr1 value, such as Table 2 depicted above, if a block, slice, or frame of video data being coded has a first characteristic (e.g., intra coded), and to select a second table that also defines an lrg1Pos value for more than one potential noTr1 value, however the lrg1Pos values can be different between the first and second tables. In some examples, the coder 250, 350 could further be configured to select from one or more of such tables that are each dedicated to one or more of the characteristics of a frame, slice, or block described above, to determine lrg1Pos values for transform coefficients of the frame, slice, or block. In still other examples, instead of, or in addition to, selecting from among a plurality of such tables dedicated to frame, slice, or block characteristics, the coder 250, 350 can be configured to select from a plurality of mapping functions each dedicated to one or more of the characteristics described above. According to these examples, the coder 250, 350 is configured to adapt a mapping used to determine lrg1Pos values to particular characteristics of a frame, slice, or block of video data, which improve the efficiency of the coder to code the video data.

As described above, in some examples consistent with the techniques described herein, the coder 250, 350 is configured to select from among a plurality of tables to determine an lrg1Pos value, where each of the tables defines an lrg1Pos value associated with more than one potential noTr1 value for a particular scan. In other examples, the coder 250, 350 can store and use some tables where at least one lrg1Pos value is associated with more than one potential noTr1 value, such as Table 2 above, and for at least one other table of such a plurality of tables, store and use a table that defines a different value of lrg1Pos, for each potential combination of noTr1 and position k, such as Table 1 above. According to these examples, the coder 250, 350 could optionally use the larger table such as Table 1 to improve accuracy for some coefficients/characteristics of video data, and use the smaller table such as Table 2 for other coefficients/characteristics of video data.

As described above, according to various examples, the coder 250, 350 is configured to select from among a plurality of tables stored in memory that is used to map lrg1Pos values. In other examples consistent with this disclosure, the coder 250, 350 can also be configured to use different mapping functions for different tables selected by a coder to map lrg1Pos values. For example, a first mapping function indicates that a first row of Table 2 above is to be used for a first (0) and fifth (4) potential value of noTr1, as described according to the example set forth above. However, for another of the plurality of tables, the coder 250, 350 could use a mapping function that defines that the first row of Table 2 is to be used for the second (1) and fifth (4) potential values of noTr1, and the second row of Table to is to be used for the first (0), third (2), and fourth (5) potential values of noTr1.

The techniques of this disclosure are described above as performed by the coder 250, 350, which comprises an encoder or a decoder device. For example, the encoder 250 determines values for level_ID and run syntax elements associated with a transform coefficient of a block of video data, and use the techniques described herein to determine an lrg1Pos value and use the determined lrg1Pos value to perform a structured mapping between the determined level_ID and run syntax elements and a code number cn. The encoder 250 can then use the determined code number cn to determine a VLC code word that represents the level_ID and run syntax elements, and output the VLC code word as part of an entropy encoded bit stream. The decoder 350 could read such a VLC code word from such an entropy encoded bit stream, and use the VLC code word to determine a code number cn. The decoder 350 can also use the techniques described herein to determine an lrg1Pos value associated with the transform coefficient, and use the lrg1Pos value to perform a structured mapping between the determined code number cn and values for the level_ID and run syntax elements. The decoder 350 can use the determined values for the level_ID and run syntax elements, to decode one or more transform coefficients of the block of video data.

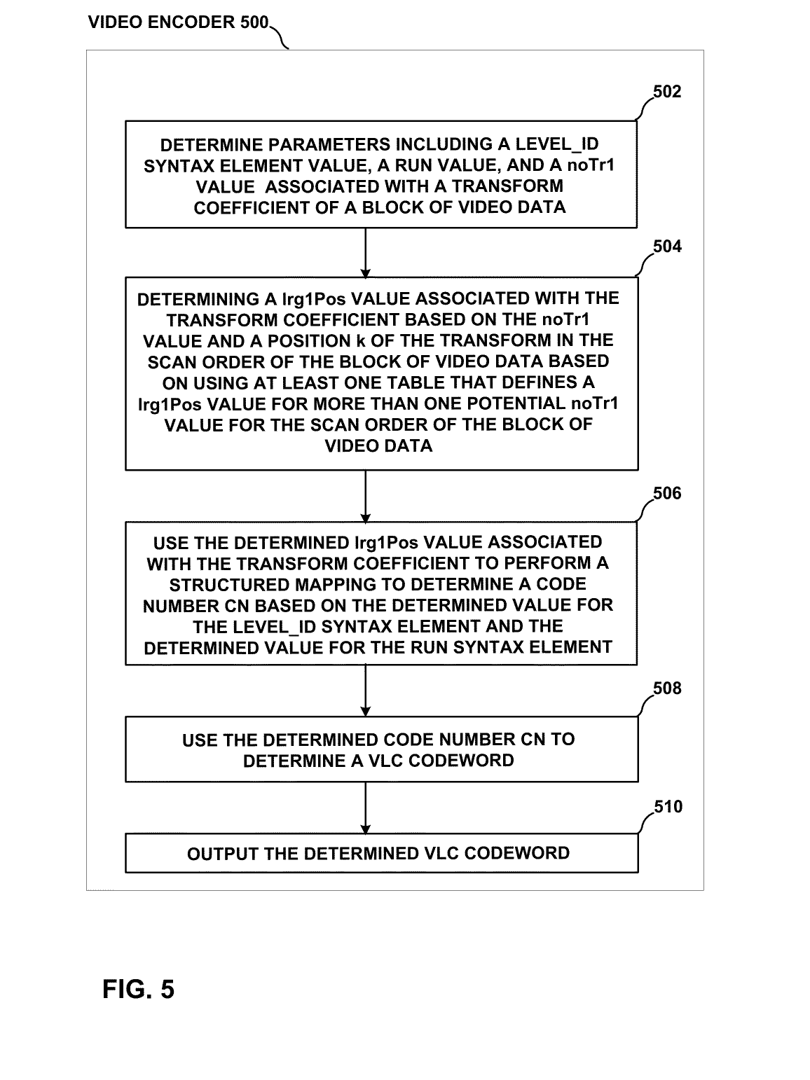

FIG. 5 is a flow diagram that illustrates one example of a method that can be performed by an encoder to code transrun syntaform coefficients consistent with one or more aspects of this disclosure. According to the method of FIG. 5, encoder 500 (e.g. the video encoder 250 of FIG. 2) determines parameters including run, level_ID, and noTr1 syntax element values associated with a transform coefficient of a block of transform data (502). As described above, memory is conserved by determining an lrg1Pos value associated with the transform coefficient based on the noTr1 value and a position k of the transform in the scan order of the block of video data based on using at least one table that defines an lrg1Pos value for more than one potential noTr1 value for the scan order of the block of video data (504). The determined lrg1Pos value associated with the transform coefficient is used to perform a structured mapping to determine a code number cn based on the determined value for the level_ID syntax element and the determined value for the run syntax element (506), and the code number cn is in turn used to determine a VLC code word (508) that comprises the output of the encoder (510).

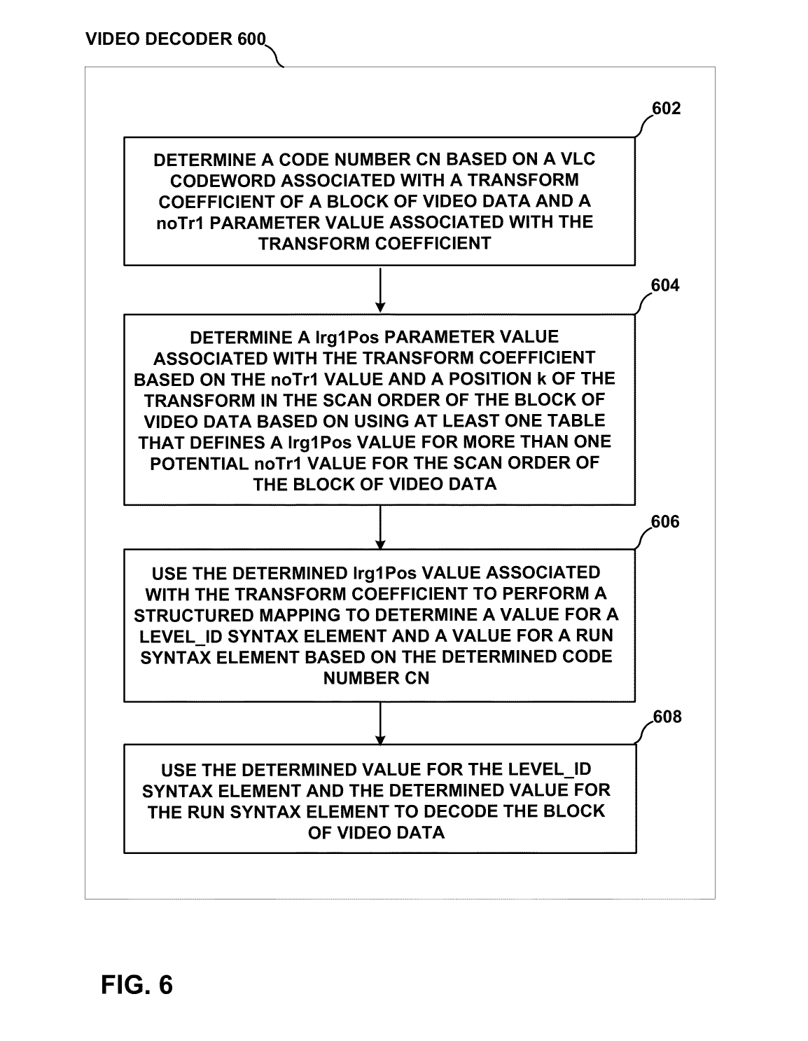

FIG. 6 is a flow diagram that illustrates one example of a method that can be performed by a decoder to decode transform coefficients consistent with one or more aspects of this disclosure, and is essentially the inverse of the method illustrated in FIG. 5. According to the method of FIG. 6, encoder 600 (e.g. the video decoder 350 of FIG. 3) determines a code number cn based on a VLC code word associated with a transform coefficient of a block of video data and a noTr1 value associated with the transform coefficient, wherein the noTr1 value indicates a number of previously coded transform coefficients of the block with an amplitude equal to one (602). The decoder 600 then determines an lrg1Pos value associated with the transform coefficient based on the noTr1 value and a position k of the transform in the scan order of the block of video data based on using at least one table that defines an lrg1Pos value for more than one potential noTr1 value for the scan order of the block of video data (604). The determined value of lrg1Pos associated with the transform coefficient is used to perform a structured mapping to determine a value for a level_ID syntax element and a value for a run syntax element based on the determined code number cn (606). Finally the determined values for the level_ID syntax element and a value for a run syntax element are used to decode the block of video data (608).

The function used to map the input values of noTr1 and k to lrg1Pos values in the examples of FIG. 5 and FIG. 6 is not restricted and can assume many forms. Some examples include a fixed predetermined mapping, a function that changes dynamically based on context, a piecewise continuous function that performs distinct operations for different groups of transform coefficients within the same video stream, e.g. lrg1Pos₁=F′₁(noTr1,k)ᵢ, lrg1Pos₂=F′₂(noTr1,k)ⱼ, . . . lrg1Pos_{N}=F′_{N}(noTr1,k)ₘ (where the indexes i,j, and m represent different groups of input parameters and the lrg1Pos_{N} represent different mapping functions) or any combination of the above.

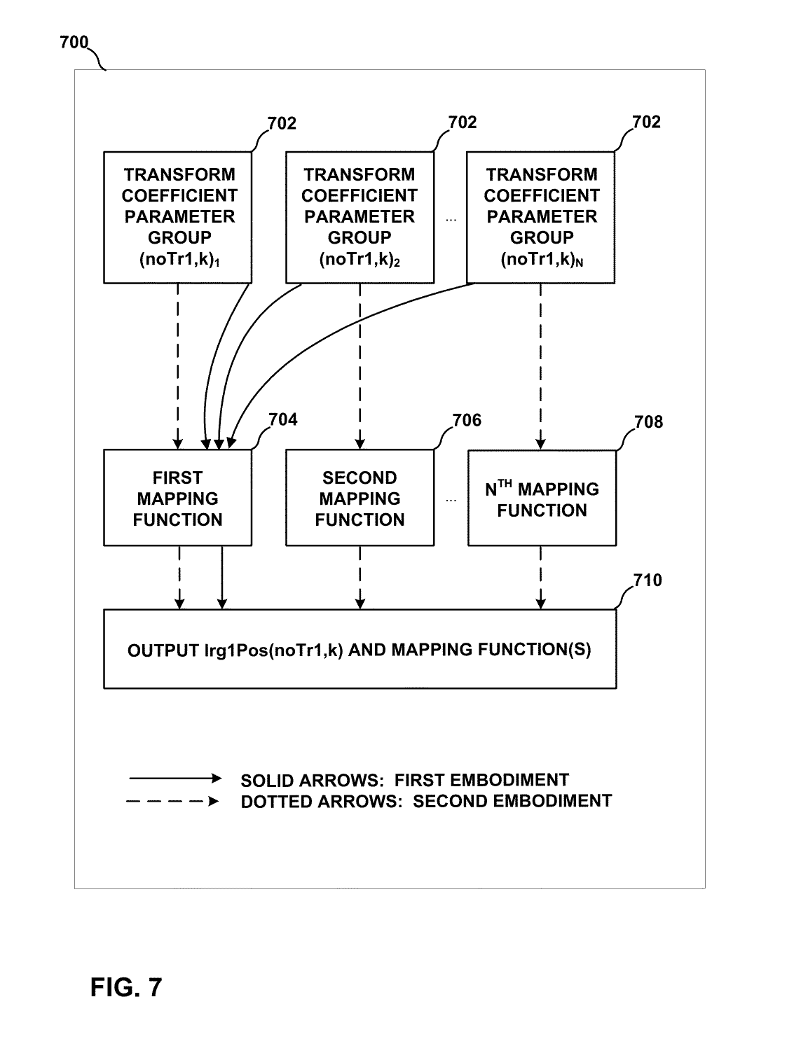

Some examples of the use of the mapping function F′( ) consistent with one or more aspects of this disclosure are shown conceptually in the flow diagram of FIG. 7. In this illustration, the transform coefficients of the video stream input are divided into groups 1 through N (702). In one embodiment (solid arrows), the transform coefficients 702 are all mapped in the same manner using a first mapping function 704. In another embodiment, embodiment (dotted arrows), subsets of the transform coefficients 702 are mapped using different mapping functions 704, 706, and 708, each of which could, for example, resemble Table 2 above, to determine lrg1Pos for each value of noTr1 and k. These values are output to a decoder along with the one or more mapping functions (710).

In some embodiments, at least one of the one or more mapping functions is adaptive or dynamic. The mapping function can be based on one or more characteristics associated with the block such as a prediction type (e.g., intra or inter coded prediction type); a color component (e.g., luma or chroma); a motion partition (e.g., 2N×N, N×2N or 2N×2N); a motion partition size; a transform block size; one or more quantization parameters; a motion vector amplitude; or one or more motion vector predictions.

Further embodiments include a system and method of basing the mapping function on one or more characteristics of previously encoded transform coefficients associated with video block locations in a neighboring region R. The characteristics on which the mapping function are based include, but are not limited to, one or more of the summation of the absolute values of the transform coefficient in the neighboring region R and the number of non-zero transform coefficients in the neighboring region R. Depending on choice of implementation the region R itself can optionally be fixed and predetermined, or can be changed adaptively by the encoder in response to characteristics of the video stream, hardware context, or other parameters. In other examples the region R could be configurable based user input. In some embodiments, neighboring region R and the transform coefficients associated with video block locations there within are transmitted to a decoder as overhead information.

In one or more examples, the functions described herein are implemented at least partially in hardware, such as specific hardware components or a processor. More generally, the techniques are implemented in hardware, processors, software, firmware, or any combination thereof. If implemented in software, the functions are stored on or transmitted over as one or more instructions or code on a computer-readable medium and executed by a hardware-based processing unit. Computer-readable media can include computer-readable storage media, which corresponds to a tangible medium such as data storage media, or communication media including any medium that facilitates transfer of a computer program from one place to another, e.g., according to a communication protocol. In this manner, computer-readable media generally correspond to (1) tangible computer-readable storage media which is non-transitory or (2) a communication medium such as a signal or carrier wave. Data storage media is potentially any available media that can be accessed by one or more computers or one or more processors to retrieve instructions, code and/or data structures for implementation of the techniques described in this disclosure. A computer program product optionally includes a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions can be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein can refer to any of the foregoing structure or any other structure suitable for implementation of the techniques described herein. In addition, in some aspects, the functionality described herein is provided within dedicated hardware and/or software modules configured for encoding and decoding, or incorporated in a combined codec. Also, the techniques could be fully implemented in one or more circuits or logic elements.

The techniques of this disclosure can potentially be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units can be combined in a codec hardware unit or provided by a collection of interoperative hardware units, including one or more processors as described above, in conjunction with suitable software and/or firmware.

Various examples been described. These and other examples are within the scope of the following claims.

1. A method for encoding a block of video data, comprising:
determining a value of a level_ID syntax element associated with a transform coefficient of a block of video data, wherein the level_ID syntax element indicates whether the transform coefficient has a magnitude of one or greater than one;
determining a run value associated with the transform coefficient, wherein the run value indicates a number of zero-value coefficients between the current coefficient and a next non-zero coefficient in a scan order of the block of video data;
determining a noTr1 value associated with the transform coefficient, wherein the noTr1 value indicates a number of previously coded transform coefficients of the block with an amplitude equal to one;
determining the value of and storing in memory at least one parameter associated with the transform coefficient based on the noTr1 value and a position k of the transform in the scan order of the block of video data based on using at least one table that defines one value of the at least one parameter for more than one potential noTr1 value for the scan order of the block of video data; and
using the determined value of the at least one parameter associated with the transform coefficient to perform a structured mapping to determine a code number cn based on the determined value for the level_ID syntax element and the determined value for the run syntax element;
using the determined code number cn to determine a VLC code word; and
outputting the determined VLC code word.

2. The method of claim 1, wherein determining the value of the at least one parameter associated with the transform coefficient based on using the at least one table that defines one value of the at least one parameter for more than one potential noTr1 value for the scan order of the block of video data comprises using a mapping function to access the at least one table.

3. The method of claim 2, wherein the mapping function defines at least one plurality of potential noTr1 values that correspond to a single entry in the at least one table.

4. The method of claim 2, wherein the mapping function defines a first plurality of potential noTr1 values that correspond to a first entry in the at least one table, and at least a second plurality of potential noTr1 values that correspond to a second entry in the at least one table.

5. The method of claim 2, further comprising:
outputting the mapping function.

6. The method of claim 2, wherein the mapping function comprises a first mapping function, and further comprising:
for a first plurality of transform coefficients of the block of video data, using the first mapping function to access the at least one table; and
for a second plurality of transform coefficients of the block of video data, using a second mapping function different than the first mapping function to access the at least one table.

7. The method of claim 1, further comprising:
determining the at least one parameter associated with the transform coefficient based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

8. The method of claim 1, further comprising:
determining the value of the at least one parameter associated with the transform coefficient based on using at least one table that defines one value associated with the transform coefficient for more than one potential noTr1 value for a first plurality of transform coefficients of the scan order of the block of video data; and
determining the value of the at least one parameter associated with the transform coefficient based on using at least one table that defines one value of the at least one parameter for each one potential noTr1 value for a second plurality of transform coefficients of the scan order of the block of video data.

9. The method of claim 1, wherein the at least one value associated with the transform coefficient comprises an lrg1Pos value.

10. The method of claim 1, wherein determining a value of the at least one parameter associated with the transform coefficient based on the noTr1 value and a position k of the transform in the scan order of the block of video data based on using at least one table that defines a value of the at least one parameter for more than one potential noTr1 value for the scan order of the block of video data comprises selecting the at least one table based on one or more characteristics of previously encoded transform coefficients associated with video block locations in a neighboring region R.

11. The method of claim 10, wherein the one or more characteristics of previously encoded transform coefficients associated with video block locations in a neighboring region R used to select the at least one table include one or more characteristics selected from the group consisting of:
a summation of the absolute values of the transform coefficients in the neighboring region R; and
a number of non-zero transform coefficients in the neighboring region R.

12. The method of claim 10, wherein the neighboring region R is selected by the user or the encoder and the values of the transform coefficients within neighboring region R are transmitted to a decoder as overhead information.

13. The method of claim 12, wherein the neighboring region R is adaptively selected based on based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

14. A device for encoding a block of video data, comprising a processor configured to:
determine a value of a level_ID syntax element associated with a transform coefficient of a block of video data, wherein the level_ID syntax element indicates whether the transform coefficient has a magnitude of one or greater than one;
determine a run value associated with the transform coefficient, wherein the run value indicates a number of zero-value coefficients between the current coefficient and a next non-zero coefficient in a scan order of the block of video data;
determine a noTr1 value associated with the transform coefficient, wherein the noTr1 value indicates a number of previously coded transform coefficients of the block with an amplitude equal to one;
determine a value of at least one parameter associated with the transform coefficient based on the noTr1 value and a position k of the transform coefficient in the scan order of the block of video data based on using at least one table that defines a value of the at least one parameter for more than one potential noTr1 value for the scan order of the block of video data; and
use the determined value of the at least one parameter associated with the transform coefficient to perform a structured mapping to determine a code number cn based on the determined value for the level_ID syntax element and the determined value for the run syntax element;
use the determined code number cn to determine a VLC code word; and
output the determined VLC code word.

15. The device of claim 14, wherein determining the value of the at least one parameter associated with the transform coefficient based on using the at least one table that defines one value of the at least one parameter for more than one potential noTr1 value for the scan order of the block of video data comprises using a mapping function to access the at least one table.

16. The device of claim 15, wherein the mapping function defines at least one plurality of potential noTr1 values that correspond to a single entry in the at least one table.

17. The device of claim 15, wherein the mapping function defines a first plurality of potential noTr1 values that correspond to a first entry in the at least one table, and at least a second plurality of potential noTr1 values that correspond to a second entry in the at least one table.

18. The device of claim 15, further comprising:
a device configured to output the mapping function.

19. The device of claim 15, wherein the mapping function comprises a first mapping function, and further comprising:
for a first plurality of transform coefficients of the block of video data, using the first mapping function to access the at least one table; and
for a second plurality of transform coefficients of the block of video data, using a second mapping function different than the first mapping function to access the at least one table.

20. The device of claim 14, further comprising:
a device configured to determine the at least one parameter associated with the transform coefficient based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

21. The device of claim 14, further comprising:
a device configured to determine the value of the at least one parameter associated with the transform coefficient based on using at least one table that defines one value associated with the transform coefficient for more than one potential noTr1 value for a first plurality of transform coefficients of the scan order of the block of video data; and
a device configured to determine the value of the at least one parameter associated with the transform coefficient based on using at least one table that defines one value of the at least one parameter for each one potential noTr1 value for a second plurality of transform coefficients of the scan order of the block of video data.

22. The device of claim 14, wherein the at least one value associated with the transform coefficient comprises an lrg1Pos value.

23. The device of claim 15, wherein determining a value of the at least one parameter associated with the transform coefficient based on the noTr1 value and a position k of the transform in the scan order of the block of video data based on using at least one table that defines a value of the at least one parameter for more than one potential noTr1 value for the scan order of the block of video data comprises selecting the at least one table based on one or more characteristics of previously encoded transform coefficients associated with video block locations in a neighboring region R.

24. The device of claim 23, wherein the one or more characteristics of previously encoded transform coefficients associated with video block locations in a neighboring region R used to select the at least one table include one or more characteristics selected from the group consisting of:
a summation of the absolute values of the transform coefficients in the neighboring region R;
a summation of the absolute values of the transform coefficients in the neighboring region R; and
a number of non-zero transform coefficients in the neighboring region R.

25. The device of claim 23, wherein the neighboring region R is selected by the user or the encoder and the values of the transform coefficients within neighboring region R are transmitted to a decoder as overhead information.

27. The device of claim 25, wherein the neighboring region R is adaptively selected based on based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

27. A method for decoding a block of video data, comprising:
determining a code number cn based on a VLC code word associated with a transform coefficient of a block of video data;
determining a noTr1 value associated with the transform coefficient, wherein the noTr1 value indicates a number of previously coded transform coefficients of the block with an amplitude equal to one;
determining a value of at least one parameter associated with the transform coefficient based on the noTr1 value and a position k of the transform in the scan order of the block of video data based on using at least one table that defines a value of the at least one parameter for more than one potential noTr1 value for the scan order of the block of video data; and
using the determined value of the at least one parameter associated with the transform coefficient to perform a structured mapping to determine a value for a level_ID syntax element and a value for a run syntax element based on the determined code number cn; and
using the determined value for the level_ID syntax element and the determined value for the run syntax element to decode the block of video data.

28. The method of claim 27, wherein determining the value of the at least one parameter associated with the transform coefficient based on using the at least one table that defines one value of the at least one parameter for more than one potential noTr1 value for the scan order of the block of video data comprises using a mapping function to access the at least one table.

29. The method of claim 27, wherein the mapping function defines at least one plurality of potential noTr1 values that correspond to a single entry in the at least one table.

30. The method of claim 28, wherein the mapping function defines a first plurality of potential noTr1 values that correspond to a first entry in the at least one table, and at least a second plurality of potential noTr1 values that correspond to a second entry in the at least one table.

31. The method of claim 28, wherein the mapping function comprises a first mapping function, and further comprising:
for a first plurality of transform coefficients of the block of video data, using the first mapping function to access the at least one table; and
for a second plurality of transform coefficients of the block of video data, using a second mapping function different than the first mapping function to access the at least one table.

32. The method of claim 27, further comprising:
determining the at least one parameter associated with the transform coefficient based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

33. The method of claim 27, further comprising:
determining the value of the at least one parameter associated with the transform coefficient based on using at least one table that defines one value associated with the transform coefficient for more than one potential noTr1 value for a first plurality of transform coefficients of the scan order of the block of video data; and
determining the value of the at least one parameter associated with the transform coefficient based on using at least one table that defines one value of the at least one parameter for each one potential noTr1 value for a second plurality of transform coefficients of the scan order of the block of video data.

34. The method of claim 27, wherein the at least one value associated with the transform coefficient comprises an lrg1Pos value.

35. The method of claim 27, wherein determining a value of the at least one parameter associated with the transform coefficient based on the noTr1 value and a position k of the transform in the scan order of the block of video data based on using at least one table that defines a value of the at least one parameter for more than one potential noTr1 value for the scan order of the block of video data comprises selecting the at least one table based on one or more characteristics of previously encoded transform coefficients associated with video block locations in a neighboring region R.

36. The method of claim 35, wherein the one or more characteristics of previously encoded transform coefficients associated with video block locations in a neighboring region R used to select the at least one table include one or more characteristics selected from the group consisting of:
a summation of the absolute values of the transform coefficients in the neighboring region R; and
a number of non-zero transform coefficients in the neighboring region R.

37. The method of claim 35, wherein the neighboring region R is selected by the user or the encoder and the values of the transform coefficients within neighboring region R are transmitted to a decoder as overhead information.

38. The method of claim 37, wherein the neighboring region R is adaptively selected based on based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

39. The method of claim 27, wherein the at least one value associated with the transform coefficient comprises an lrg1Pos value.

40. A device configured to decode a block of video data, comprising:
a processor configured to:
determine a code number cn based on a VLC code word associated with a transform coefficient of a block of video data;
determine a noTr1 value associated with the transform coefficient, wherein the noTr1 value indicates a number of previously coded transform coefficients of the block with an amplitude equal to one;
determine a value of at least one parameter associated with the transform coefficient based on the noTr1 value and a position k of the transform in the scan order of the block of video data based on using at least one table that defines a value of the at least one parameter for more than one potential noTr1 value for the scan order of the block of video data; and
use the determined value of the at least one parameter associated with the transform coefficient to perform a structured mapping to determine a value for a level_ID syntax element and a value for a run syntax element based on the determined code number cn; and
use the determined value for the level_ID syntax element and the determined value for the run syntax element to decode the block of video data.

41. The device of claim 40, wherein determining the value of the at least one parameter associated with the transform coefficient based on using the at least one table that defines one value of the at least one parameter for more than one potential noTr1 value for the scan order of the block of video data comprises using a mapping function to access the at least one table.

42. The device of claim 41, wherein the mapping function defines at least one plurality of potential noTr1 values that correspond to a single entry in the at least one table.

43. The device of claim 41, wherein the mapping function defines a first plurality of potential noTr1 values that correspond to a first entry in the at least one table, and at least a second plurality of potential noTr1 values that correspond to a second entry in the at least one table.

44. The device of claim 41, wherein the mapping function comprises a first mapping function, and further comprising:
for a first plurality of transform coefficients of the block of video data, using the first mapping function to access the at least one table; and
for a second plurality of transform coefficients of the block of video data, using a second mapping function different than the first mapping function to access the at least one table.

45. The device of claim 40, further comprising:
a device configured to determine the at least one parameter associated with the transform coefficient based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

46. The device of claim 40, further comprising:
a device configured to determine the value of the at least one parameter associated with the transform coefficient based on using at least one table that defines one value associated with the transform coefficient for more than one potential noTr1 value for a first plurality of transform coefficients of the scan order of the block of video data; and
a device configured to determine the value of the at least one parameter associated with the transform coefficient based on using at least one table that defines one value of the at least one parameter for each one potential noTr1 value for a second plurality of transform coefficients of the scan order of the block of video data.

47. The device of claim 40, wherein the at least one value associated with the transform coefficient comprises an lrg1Pos value.

48. The device of claim 41, wherein determining a value of the at least one parameter associated with the transform coefficient based on the noTr1 value and a position k of the transform in the scan order of the block of video data based on using at least one table that defines a value of the at least one parameter for more than one potential noTr1 value for the scan order of the block of video data comprises selecting the at least one table based on one or more characteristics of previously encoded transform coefficients associated with video block locations in a neighboring region R.

49. The device of claim 48, wherein the one or more characteristics of previously encoded transform coefficients associated with video block locations in a neighboring region R used to select the at least one table include one or more characteristics selected from the group consisting of:
a summation of the absolute values of the transform coefficients in the neighboring region R;
a summation of the absolute values of the transform coefficients in the neighboring region R; and
a number of non-zero transform coefficients in the neighboring region R.

50. The device of claim 48, wherein the neighboring region R is selected by the user or the encoder and the values of the transform coefficients within neighboring region R are transmitted to a decoder as overhead information.

51. The device of claim 50, wherein the neighboring region R is adaptively selected based on based on one or more characteristics associated with the block, wherein the one or more characteristics include one or more characteristics selected from the group consisting of:
a prediction type (e.g., intra or inter coded prediction type);
a color component (e.g., luma or chroma);
a motion partition (e.g., 2N×N, N×2N or 2N×2N);
a motion partition size;
a transform block size;
one or more quantization parameters;
a motion vector amplitude; and
one or more motion vector predictions.

52. A computer-readable medium that includes instructions that, when executed, cause a computing device to:
determine a code number cn based on a VLC code word associated with a transform coefficient of a block of video data;
determine a noTr1 value associated with the transform coefficient, wherein the noTr1 value indicates a number of previously coded transform coefficients of the block with an amplitude equal to one;
determine a value of at least one parameter associated with the transform coefficient based on the noTr1 value and a position k of the transform in the scan order of the block of video data based on using at least one table that defines a value of the at least one parameter for more than one potential noTr1 value for the scan order of the block of video data; and
use the determined value of the at least one parameter associated with the transform coefficient to perform a structured mapping to determine a value for a level_ID syntax element and a value for a run syntax element based on the determined code number cn; and
use the determined value for the level_ID syntax element and the determined value for the run syntax element to decode the block of video data.

53. A device configured to decode a block of video data, comprising:
means for determining a code number cn based on a VLC code word associated with a transform coefficient of a block of video data;
means for determining a noTr1 value associated with the transform coefficient, wherein the noTr1 value indicates a number of previously coded transform coefficients of the block with an amplitude equal to one;
means for determining a value of at least one parameter associated with the transform coefficient based on the noTr1 value and a position k of the transform in the scan order of the block of video data based on using at least one table that defines a value of the at least one parameter for more than one potential noTr1 value for the scan order of the block of video data; and
means for using the determined value of the at least one parameter associated with the transform coefficient to perform a structured mapping to determine a value for a level_ID syntax element and a value for a run syntax element based on the determined code number cn; and
means for using the determined value for the level_ID syntax element and the determined value for the run syntax element to decode the block of video data.
